(19) United States
(12) Patent Application Publication
(10) Pub. No.: US 2026/0179937 A1
(43) Pub. Date: Jun. 25, 2026

(54) CATHODE ACTIVE MATERIAL FOR LITHIUM-ION SECONDARY BATTERY

(71) Applicant: TOYOTA JIDOSHA KABUSHIKI KAISHA, Toyota-shi (JP)

(72) Inventors: Momoko PROCTER, Seto-shi (JP); Yuji MAHARA, Seto-shi (JP); Taku KINOSHITA, Toyota-shi (JP)

(73) Assignee: TOYOTA JIDOSHA KABUSHIKI KAISHA, Toyota-shi (JP)

(21) Appl. No.: 19/357,414

(22) Filed: Oct. 14, 2025

(30) Foreign Application Priority Data
Nov. 15, 2024 (JP) 2024-199557

(51) Int. Cl. H01M 4/525; C01G 53/44; H01M 10/0525

(52) U.S. Cl. CPC H01M 4/525; C01G 53/44; C01P 2002/52; C01P 2002/76; C01P 2004/50; C01P 2006/40; H01M 10/0525

(57) ABSTRACT

A cathode active material for a lithium-ion secondary battery contains a lithium transition metal composite oxide. The lithium transition metal composite oxide mainly contains a crystal structure belonging to the space group R-3m, and the following relationship is satisfied: “a≤2.876 Å,” where a represents a lattice constant in the a-axis direction of the lithium transition metal composite oxide.

### CROSS-REFERENCE TO RELATED APPLICATION

This application claims priority to Japanese Patent Application No. 2024-199557 filed on Nov. 15, 2024. The disclosure of the above-identified application, including the specification, drawings, and claims, is incorporated by reference herein in its entirety.

### BACKGROUND

### 1. Technical Field

The present disclosure relates to cathode active materials for lithium-ion secondary batteries.

### 2. Description of Related Art

Japanese Unexamined Patent Application Publication (Translation of PCT Application) No. 2023-516229 (JP 2023-516229 A) discloses a high-nickel cathode active material. The particle size distribution of this cathode active material satisfies the following relationship: “1.5≤(D95−D5)/D50≤2.5.”

### SUMMARY

There is a demand for lithium-ion secondary batteries having high energy density. Conventionally, for example, it has been proposed to improve the energy density by enhancing the packing properties of a cathode active material through adjustment of the particle size distribution of the cathode active material.

On the other hand, in high-nickel cathode active materials such as that described in JP 2023-516229 A, contraction in the c-axis direction occurs when nickel is extracted from between the layers. This can lead to a decrease in capacity retention rate of a lithium-ion secondary battery containing this cathode active material.

An object of the present disclosure is to improve cycle characteristics.
(1) A cathode active material for a lithium-ion secondary battery contains a lithium transition metal composite oxide.
   The lithium transition metal composite oxide mainly contains a crystal structure belonging to the space group R-3m.
   The following relationship is satisfied: a≤2.876 Å,
   where a represents a lattice constant in the a-axis direction of the lithium transition metal composite oxide.

Although the detailed mechanism is unclear, it has been found that when the lattice constant “a” in the a-axis direction of the lithium transition metal composite oxide is 2.876 Å or less, the cycle characteristics are improved. Hereinafter, the “cathode active material for a lithium-ion secondary battery” may be simply referred to as “cathode active material”. The “lithium-ion secondary battery” may be simply referred to as “battery.”
(2) In the cathode active material according to (1), the following relationship may be satisfied: 4.937<c/a<4.952,
   where c represents a lattice constant in the c-axis direction of the lithium transition metal composite oxide.

Further improvement in cycle characteristics is expected when the relationship “4.937<c/a<4.952” is satisfied.
(3) In the cathode active material according to (1) or (2), the following relationship may be satisfied: 2.872 Å≤a.
(4) In the cathode active material according to any one of (1) to (3), the lithium transition metal composite oxide may have a composition represented by the following general formula: LiₓNi_{d}CoₑMn_{f}O_{y},
   where x, d, e, f, and y satisfy the following relationships: 0.1≤x≤1.5, 0.5≤d≤1.0, 0≤e≤0.3, 0≤f≤0.3, d+e+f=1.0, and 1.5≤y≤2.1.
(5) In the cathode active material according to any one of (1) to (4), the lithium transition metal composite oxide may be in the form of a powder,
   In the powder, the number fraction of single-crystal particles relative to the total of the single-crystal particles and polycrystalline particles may be 70% or more.
   The single-crystal particle may contain one to ten primary particles.
   The polycrystalline particle may contain more than ten primary particles.

An embodiment of the present disclosure (hereinafter also referred to as “present embodiment”) and an example of the present disclosure (hereinafter also referred to as “present example”) will be described. However, the present embodiment and the present example are not intended to limit the technical scope of the present disclosure. The present embodiment and the present example are illustrative in all respects. The present embodiment and the present example are not restrictive. The technical scope of the present disclosure includes all modifications that fall within the meaning and scope equivalent to the claims. For example, it is originally intended that any configurations may be extracted from the embodiment and combined as desired.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram of a layered structure; and

FIG. 2 is a table showing experimental results.

### DETAILED DESCRIPTION OF EMBODIMENTS

The terms “Comprise,” “include,” “have,” and their variations are open-ended expressions. A configuration expressed in an open-ended manner may or may not include additional elements in addition to essential elements. The term “consist of” is a closed-ended expression. Even a configuration expressed in a closed-ended manner may include additional elements such as incidental impurities or elements irrelevant to the target technology. The term “substantially consist of” is a semi-closed-ended expression. In a configuration expressed in a semi-closed-ended manner, it is allowed to add elements that do not substantially affect the fundamental and novel characteristics of the target technology.

Numerical values may be expressed in significant figures. Measured values may be the averages of multiple measurements, unless otherwise specified. The number of measurements may be three or more, five or more, or 10 or more. Typically, the larger the number of measurements, the higher the reliability of the average is expected to be. Measured values may be rounded based on the number of significant figures. Measured values may include errors such as those associated with the detection limits of measurement devices.

The devices, software, etc. used for measuring various values are merely examples. Devices etc. equivalent to those exemplified herein may be used. When an equivalent device is used, the measurement conditions may be adjusted in accordance with the device.

The crystal structure is identified by Rietveld analysis of an X-ray diffraction (XRD) pattern. First, a powder XRD pattern of a cathode active material is obtained. For example, the XRD measurement may be performed at beamline “BL5S2” of “Aichi Synchrotron Radiation Center.” For the measurement, the sample (cathode active material) is sealed in a glass capillary tube (inner diameter: 0.5 mm). The irradiation energy is 17 keV. The measurement time is 10 minutes.

Subsequently, the XRD pattern is analyzed using the analysis software “GSAS-II.” Refinement is performed using the phase with the space group R-3m. As an example, a procedure will be described for a case where the cathode active material has a composition of LiNi_{0.90}Co_{0.05}Mn_{0.05}O₂. The occupancy of Li at the 3a site (Li layer site) is expressed as “1-x,” and the occupancy of Ni at this site is expressed as “x.” At the 3b site (transition metal (TM) layer site), the occupancy of Ni is expressed as “0.90-x,” the occupancy of Co as “0.05,” the occupancy of Mn as “0.05,” and the occupancy of Li as “x.” The most probable structure is estimated by refining “x.” The lattice constants in the a-axis and c-axis directions of the obtained phase are defined as the a-axis length “a” and the c-axis length “c”, respectively.

When the obtained XRD pattern exhibits the following features, the sample (cathode active material) is regarded as mainly containing a crystal structure belonging to the space group R-3m. The horizontal axis (2θ) of the XRD pattern is converted to an energy scale using CuKα (8042.55 eV). In the converted XRD pattern, a peak with the maximum intensity is present in the range of 18° to 20°. A peak with the second highest intensity is present in the range of 440 to 45°. A split peak is present in the range of 63.5° to 65.5°.

A stoichiometric formula represents a representative composition of a compound. The compound may have a non-stoichiometric composition. For example, “Al₂O₃” is not limited to compounds having a mole ratio of “Al/O=2/3.” Unless otherwise specified, “Al₂O₃” refers to compounds containing Al and O in any mole ratio. For example, the compound may be doped with a trace element. Al and O may be partially substituted with another element.

The chemical composition of the cathode active material may be measured by inductively coupled plasma atomic emission spectroscopy (ICP-AES). A sample solution is prepared by dissolving 0.1 g of the sample (cathode active material) in a mixed acid (10 mL) of hydrochloric acid and sulfuric acid. The sample solution is then diluted to an appropriate concentration using a volumetric flask. After dilution, compositional analysis is conducted using an ICP-AES device. For example, a product such as “PS3520UVDDII (manufactured by Hitachi High-Tech Corporation)” may be used.

The term “primary particle” refers to the smallest unit of a particle, recognized as a solid particle that defines the boundary between particles and that cannot be further divided. The number of primary particles contained in a single-crystal or polycrystalline particle is counted using scanning electron microscope (SEM) images of the powder. The magnification of the images is, for example, 10,000×. A single primary particle, or an aggregate of 2 to 10 primary particles, is regarded as a single-crystal particle. An aggregate of more than 10 primary particles is regarded as a polycrystalline particle.

“D50” refers to the particle size at which the cumulative frequency reaches 50% in a volume-based particle size distribution (cumulative distribution). D50 may be measured by, for example, a laser diffraction method.

### Cathode Active Material

The cathode active material is for use in a battery. The battery may be a liquid battery or an all-solid-state battery. The battery may have any structure. The battery may have, for example, a wound or stacked power generation element. The battery may have, for example, a unipolar structure or a bipolar structure.

The cathode active material contains a lithium transition metal composite oxide. A lithium transition metal composite oxide refers to a compound containing Li, TM, and O. The lithium transition metal composite oxide mainly contains a crystal structure belonging to the space group R-3m. The lithium transition metal composite oxide may substantially consist of a crystal structure belonging to the space group R-3m. A crystal structure belonging to the space group R-3m is also referred to as “layered structure.”

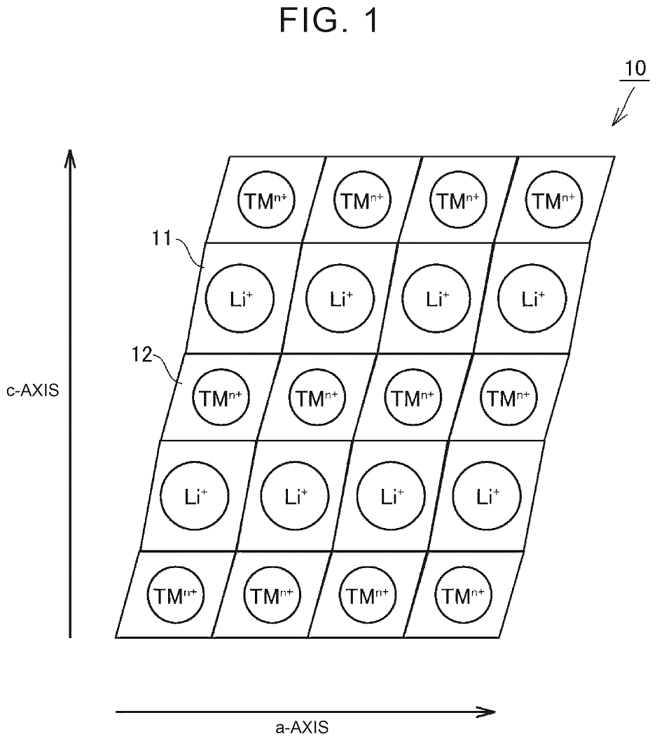

FIG. 1 is a conceptual diagram of a layered structure. A layered structure 10 includes 3a sites 11 and 3b sites 12. There are 6c sites (not shown) between the 3a and 3b sites 11, 12. The 3a sites 11 and the 3b sites 12 are alternately stacked in the c-axis direction. The 3a sites 11 are also referred to as Li layers. The 3a sites 11 store Li ions (Li⁺). The 3b sites 12 are also referred to as TM layers. The 3b sites 12 store transition metal ions (TMⁿ⁺). The 3b sites 12 contain at least Ni ions (Ni⁺).

In the layered structure, the lattice constant “a” in the a-axis direction is 2.876 Å or less. With the lattice constant “a” in the a-axis direction being 2.876 Å or less, improvement in cycle characteristics is expected. The lattice constant “a” in the a-axis direction may be, for example, 2.875 Å or less, or 2.874 Å or less. The lattice constant “a” in the a-axis direction may be, for example, 2.872 Å or more, or 2.873 Å or more.

In the layered structure, the lattice constant “c” in the c-axis direction may be 14.195 Å or more, 14.198 Å or more, 14.200 Å or more, 14.205 Å or more, or 14.209 Å or more. The lattice constant “c” in the c-axis direction may be 14.230 Å or less, 14.225 Å or less, 14.220 Å or less, or 14.215 Å or less.

In the layered structure, the ratio “c/a” of the lattice constant “c” in the c-axis direction to the lattice constant “a” in the a-axis direction (hereinafter referred to as “lattice constant ratio”) may be greater than 4.937 and less than 4.952. When the lattice constant ratio “c/a” is greater than 4.937 and less than 4.952, further improvement in cycle characteristics is expected. The lattice constant ratio “c/a” may be, for example, 4.940 or more, 4.941 or more, 4.942 or more, 4.943 or more, or 4.944 or more. The lattice constant ratio “c/a” may be, for example, 4.949 or less, 4.948 or less, or 4.947 or less.

The lithium transition metal composite oxide may have a composition represented by, for example, the following general formula: “LiₓNi_{d}COₑMn_{f}O_{y}.” In the general formula, the Li composition ratio “x” may satisfy, for example, the following relationship: “0.1≤x≤1.5.” The Li composition ratio “x” may be, for example, 0.4 or more, 0.6 or more, 0.8 or more, 1.0 or more, 1.2 or more, or 1.4 or more. The Li composition ratio “x” may be, for example, 1.4 or less, or 1.2 or less.

In the above general formula, the O composition ratio “y” may satisfy, for example, the following relationship: “1.5≤y≤2.1.” The O composition ratio “y” may be, for example, 1.6 or more, 1.7 or more, 1.8 or more, 1.9 or more, or 2.0 or more. The O composition ratio “y” may be, for example, 2.0 or less, 1.9 or less, 1.8 or less, 1.7 or less, or 1.6 or less.

In the above general formula, the Ni composition ratio “d,” the Co composition ratio “e,” and the Mn composition ratio “f” may satisfy the following relationship: “d+e+f=1.0.” The Ni composition ratio “d” may satisfy, for example, the following relationship: “0.5≤d≤1.0.” The Ni composition ratio “d” may be, for example, 0.6 or more, 0.7 or more, 0.8 or more, or 0.9 or more. The Ni composition ratio “d” may be, for example, 0.9 or less, 0.8 or less, 0.7 or less, or 0.6 or less.

In the above general formula, the Co composition ratio “e” may satisfy, for example, the following relationship: “0≤e≤0.3.” The Co composition ratio “e” may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Co composition ratio “e” may be, for example, 0.25 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

In the above general formula, the Mn composition ratio “f” may satisfy, for example, the following relationship: “0≤f≤0.3.” The Mn composition ratio “f” may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Mn composition ratio “f” may be, for example, 0.25 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

In the above general formula, all or part of Mn may be substituted with Al etc. That is, the lithium transition metal composite oxide may have a composition represented by, for example, the following general formula: “LiₓNi_{d}COₑAl_{f}O_{y}.” The range of the Al composition ratio “f” is the same as that of the Mn composition ratio “f” described above.

Any dopant may be added to the lithium transition metal composite oxide. The dopant herein refers to an element other than Li, Ni, Co, Mn, and O. The dopant may include, for example, at least one selected from the group consisting of Zr, Mo, W, Mg, Ca, Na, Fe, Cr, Zn, Si, Sn, Al, and Ag. The composition ratio of the dopant may be, for example, 0.05 or more, 0.01 or more, 0.02 or more, 0.03 or more, or 0.04 or more. The composition ratio of the dopant may be, for example, 0.05 or less, 0.04 or less, 0.03 or less, 0.02 or less, or 0.01 or less.

The cathode active material may be in the form of a powder. The D50 of the cathode active material may be, for example, 1 μm or more, 3 μm or more, 5 μm or more, 10 μm or more, or 15 μm or more. The D50 of the powder may be, for example, 30 μm or less, 20 μm or less, or 10 μm or less.

The lithium transition metal composite oxide may be in the form of single-crystal particles. The lithium transition metal composite oxide may be in the form of polycrystalline particles. That is, the cathode active material may contain single-crystal particles and polycrystalline particles. The polycrystalline particles may have substantially the same crystal structure and composition as the single-crystal particles. The cathode active material (powder) may contain, for example, 50% or more by number of the single-crystal particles, with the remainder being the polycrystalline particles. The number fraction of the single-crystal particles may be, for example, 60% or more, 70% or more, 80% or more, or 90% or more. The number fraction of the single-crystal particles may be, for example, 100% or less, 90% or less, or 80% or less. For example, when the number fraction of the single-crystal particles is 70% or more, improvement in cycle characteristics is expected. Since single-crystal particles have fewer particle boundaries than polycrystalline particles, they are considered to be less susceptible to cracking due to charging and discharging (volume changes).

The fewer the number of primary particles constituting a single-crystal particle, the less likely cracking is expected to occur. The number of primary particles constituting a single-crystal particle may be, for example, nine or fewer, eight or fewer, seven or fewer, six or fewer, five or fewer, four or fewer, three or fewer, or two or fewer. The number of primary particles constituting a polycrystalline particle may be, for example, 15 or more, 20 or more, 25 or more, or 50 or more. The number of primary particles constituting a polycrystalline particle may be, for example, 100 or fewer, 50 or fewer, 25 or fewer, or 20 or fewer. For example, when a single-crystal particle is redefined as containing five or fewer primary particles, the above number fraction shall be regarded as indicating the number fraction of single-crystal particles according to the redefinition.

The cathode active material (powder) may be monodisperse. When the powder is mainly made up of single-crystal particles and is monodisperse, improvement in cycle characteristics can be expected. The powder may have, for example, a span of 1 or less. The “span” refers to a value calculated by the following formula: “(D90−D10)/D50.” A smaller span is considered to indicate a sharper particle size distribution. The span of the powder may be, for example, 0.9 or less, 0.8 or less, 0.7 or less, 0.6 or less, or 0.5 or less. The span of the powder may be, for example, 0.1 or more, 0.2 or more, 0.3 or more, 0.4 or more, or 0.5 or more.

### Sample Fabrication

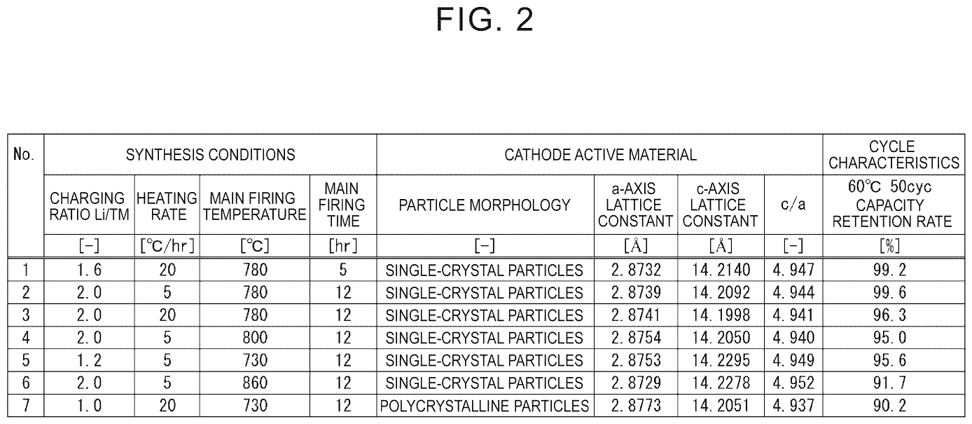

FIG. 2 is a table showing experimental results. Samples No. 1 to No. 7 were fabricated by the following procedure.

Synthesis of TM Precursor (TM hydroxide)

A raw material solution is prepared by dissolving NiSO₄, CoSO₄, and MnSO₄ in deionized water. The mixing ratio (mole ratio) of NiSO₄, CoSO₄, and MnSO₄ is “Ni/Co/Mn=90/5/5.” The molar concentration of the raw material solution is 0.2%.

A predetermined amount of NH₃ aqueous solution is placed into a reaction vessel. While the inside of the reaction vessel is being stirred with a stirrer, the reaction vessel is purged with nitrogen. NaOH is added to the reaction vessel to adjust the pH of the aqueous solution to a pH in the alkaline range. While the temperature and pH of the aqueous solution are adjusted to remain within a certain range (substantially constant), the raw material liquid is added dropwise, thereby forming a precipitate of a TM hydroxide (Ni hydroxide). The precipitate is subjected to dehydration and pre-firing. The pre-firing temperature is from 120° C. to 220° C. The pre-firing time is from four hours to ten hours. The pre-firing pressure is from 0.2 MPa to 1.0 MPa.

After the pre-firing, the precipitate is washed with water. The residue (TM hydroxide) is recovered by filtration. The TM hydroxide is dried at 110° C. for 12 hours to remove moisture. After drying, the TM hydroxide is mixed with an Li compound (LiOH) to form a mixture. The Li compound may be, for example, Li₂CO₃. The mixing ratio is adjusted such that the mole ratio “Li/TM,” that is, the ratio of the amount of Li to the total amount of TM, has the value shown in the “charging ratio” column under “synthesis conditions” in FIG. 2. When Li/TM is greater than 1, LiOH is considered to be in excess relative to the TM hydroxide. When LiOH is in excess, the lithium transition metal composite oxide tends to form single-crystal particles. That is, the number fraction of single-crystal particles in the powder is expected to be 70% or higher.

The mixture is subjected to main firing in a firing furnace, thereby forming a fired material. The firing furnace may be, for example, a muffle furnace. The heating rate, the main firing temperature, and the main firing time are shown in the “heating rate,” “main firing temperature,” and “main firing time” columns under “synthesis conditions” in FIG. 2.

The fired material is pulverized in an agate mortar until the particle size becomes 0.2 mm or less, thereby forming a pulverized material. The pulverized material is dispersed in 500 mL of pure water to form a slurry. The slurry is vigorously stirred for one minute. The slurry is then filtered using filter paper and a Buchner funnel. The resulting residue is rinsed with 500 mL of pure water to form a cake. The cake is vacuum dried at 90° C. After drying, the cake is pulverized in an agate mortar and thus adjusted to a predetermined particle size. Instead of using an agate mortar, the cake may be pulverized using, for example, a laboratory mill. A lithium transition metal composite oxide is produced in this manner. In Samples No. 1 to No. 7, the composition of the lithium transition metal composite oxide is LiNi_{0.09}Co_{0.05}Mn_{0.05}O₂. The lattice constant “a” in the a-axis direction and the lattice constant “c” in the c-axis direction of each sample are measured by Rietveld analysis. From SEM images, the number fraction of single-crystal particles is confirmed for each sample. In the “particle morphology” column under “cathode active material” in FIG. 2, when the number fraction of single-crystal particles is 70% or more, the sample is indicated as “single-crystal particles,” and when the number fraction of polycrystalline particles is 70% or more, the sample is indicated as “polycrystalline particles.”

### Evaluation

A laminated cell is prepared. The laminated cell refers to a cell in which a power generation element is housed in a pouch made of an aluminum (Al) laminate film. The configuration of the power generation element is as follows.
Cathode: cathode active material (lithium transition metal composite oxide), electrically conductive material (acetylene black)
Anode: anode active material (natural graphite)
Electrolyte: LiPF₆ (1 mol/L), EC/DMC/EMC=3/4/3 (volume ratio)

The cathode and the anode are each produced by coating a surface (metal foil) with the slurry. For example, a film applicator (with a film thickness control function) manufactured by Allgood Co., Ltd. is used as a coating device. After coating with the slurry, the coating film is dried at 80° C. for five minutes.

A cycle test under the following conditions is conducted using the laminated cell.
Ambient temperature: 60° C.
Number of cycles: 50
Current rate: 0.3 C
Voltage range: 4.25 V to 2.5 V

At a current rate of 1 C, the rated capacity of the cell is discharged in one hour. The 0.3 C rate is 0.3 times the 1 C rate. The capacity retention rate is calculated by dividing the discharge capacity at the 50th cycle by the discharge capacity at the first cycle.

### Experimental Results

In FIG. 2, when the relationship “a≤2.876 Å” is satisfied, the cycle characteristics tend to be improved. When the relationship “4.937<c/a<4.952” is satisfied, the cycle characteristics tend to be further improved.

What is claimed is:

1. A cathode active material for a lithium-ion secondary battery, the cathode active material containing a lithium transition metal composite oxide, wherein:
the lithium transition metal composite oxide mainly contains a crystal structure belonging to a space group R-3m; and
the following relationship is satisfied:
a≤2.876 Å,
where a represents a lattice constant in an a-axis direction of the lithium transition metal composite oxide.

2. The cathode active material according to claim 1, wherein the following relationship is satisfied:
4.937<c/a<4.952,
where c represents a lattice constant in a c-axis direction of the lithium transition metal composite oxide.

3. The cathode active material according to claim 1, wherein the following relationship is satisfied:
2.872 Å<a.

4. The cathode active material according to claim 1, wherein the lithium transition metal composite oxide has a composition represented by the following general formula:
LiₓNi_{d}COₑMn_{f}O_{y},
where x, d, e, f, and y satisfy the following relationships: 0.1≤x≤1.5, 0.5≤d≤1.0, 0≤e≤0.3, 0f≤0.3, d+e+f=1.0, and 1.5≤y≤2.1.

5. The cathode active material according to claim 1, wherein:
the lithium transition metal composite oxide is in a form of a powder;
in the powder, a number fraction of single-crystal particles relative to a total of the single-crystal particles and polycrystalline particles is 70% or more;
the single-crystal particle contains one to ten primary particles; and
the polycrystalline particle contains more than ten primary particles.
